(19) United States
(12) Patent Application Publication
(10) Pub. No.: US 2026/0290995 A1
(43) Pub. Date: Sep. 24, 2026

(54) SEALING LAMINATE FOR A BATTERY ASSEMBLY

(71) Applicant: ILLINOIS TOOL WORKS INC., Glenview, IL (US)

(72) Inventors: Emma MINELLI, Milan (IT); Malgorzata G ECKA, Gdansk (PL); Ignatius de WILDE, Kortgene (NL)

(21) Appl. No.: 19/572,270

(22) Filed: Mar. 19, 2026

(30) Foreign Application Priority Data
Mar. 21, 2025 (EP) 25165480.2
Mar. 7, 2026 (DE) 102026109424.4

(51) Int. Cl. H01M 50/342; F16K 17/16

(52) U.S. Cl. CPC H01M 50/3425; F16K 17/16

(57) ABSTRACT

The present disclosure provides a sealing structure for sealing a vent of a battery assembly. The sealing structure comprises a sealing layer comprising a rupturable material extending intactly across the sealing structure. The sealing layer is adapted to rupture and open a fluid path when pressure is exerted on the sealing layer.

### TECHNICAL FIELD

The present disclosure relates to a sealing structure for a battery assembly, and to a battery assembly comprising the sealing structure. The sealing structure provides protection against ingress of moisture and dirt, and also provides for venting of gases in the event of battery malfunction.

### BACKGROUND

Battery assemblies, such as secondary batteries for automotives, include a housing within which battery cells are sealed. The housing provides mechanical protection against impacts and also seals the battery cells against moisture and dirt.

It is generally known that in certain situations battery cells can overheat and catch fire. When a large number of battery cells are packed into a small space, such as in a battery pack for a vehicle, there is an increased risk of overheating. When the heat generated by an overheating battery exceeds the amount of heat dissipated to its surroundings, the increase in temperature in accelerated in a process known as thermal runaway.

During thermal runaway the pressure within the housing of the battery pack may increase, and it is known to provide vents for venting that pressure increase to the external environment.

### SUMMARY

The present disclosure provides a sealing layer comprising a rupturable material extending intactly across the sealing structure, wherein the sealing layer is adapted to rupture and open a fluid path when pressure is exerted on the sealing layer.

Beneficially, the sealing layer can be applied over a battery vent of a battery housing to provide sealing against moisture and/or dirt, and can rupture when the pressure within the battery housing rises during thermal runaway to allow pressure to be vented into the environment. The sealing layer is intact until it is ruptured, improving the sealing.

The sealing layer may comprise a rupturable, splitable or tearable material. The sealing layer may comprise a foam, for example a cellular foam, for example a low-density polyethylene or polyurethane foam.

The sealing structure may comprise a support layer adhered to the sealing layer.

The sealing structure may be a laminate.

The support layer may comprise a polymer film, for example comprising polyethylene terephthalate, polypropylene, polyethylene, or monoaxially oriented polypropylene.

The support layer may comprise an area of weakness. The sealing layer may be adapted to rupture in a location corresponding to the area of weakness. The area of weakness may comprise a slit, for example an elongate slit or a cross-shaped slit.

The sealing structure may comprise an adhesive layer joining the sealing layer to the support layer across substantially their entire surfaces. The area of weakness may extend through the adhesive layer.

The area of weakness may comprise a through-cut in the support layer.

The area of weakness may be arranged on the sealing structure so as to be aligned with a battery vent of the battery cell and/or with a housing vent of the vent plate.

The sealing structure may comprise a plurality of areas of weakness, each being arranged to be aligned with a battery vent of a battery cell.

The sealing structure may comprise a cover layer.

The sealing structure may comprise an outer adhesive layer for adhering the sealing structure to a surface of the battery assembly. Optionally, the sealing structure may further comprise a release liner provided on the outer adhesive layer.

A further aspect of the disclosure provides a battery assembly comprising:

a battery cell having a battery vent,

a battery housing having a vent plate with a housing vent, and

the sealing structure described above, the sealing structure being positioned to cover the battery vent and/or the housing vent.

In some examples the sealing structure may be disposed between the battery cell and the vent plate.

The sealing structure may comprise a support layer attached to the sealing layer, and the support layer may be disposed to face the battery cell and the sealing layer may be disposed to face the vent plate. Alternatively, the sealing structure may comprise a support layer attached to the sealing layer, and the support layer may be disposed to face the vent plate and the sealing layer may be disposed to face the battery cell.

In other examples, the vent plate may be disposed between the sealing structure and the battery cell.

The sealing structure may comprise a support layer attached to the sealing layer, and the support layer may be disposed to face the vent plate. Alternatively, the sealing structure comprises a support layer attached to the sealing layer, and the sealing layer may be disposed to face the vent plate.

### BRIEF DESCRIPTION OF THE DRAWINGS

Examples of the invention are disclosed, by way of example only, with reference to the accompanying Figures, in which:

FIG. 1A illustrates a first battery assembly having a sealing structure.

FIG. 1B illustrates a second battery assembly having a sealing structure.

FIG. 2A illustrates a side view of an example of the sealing structure of FIG. 1A.

FIG. 2B illustrates a side view of a further example of the sealing structure of FIG. 1A.

FIG. 3A illustrates a side view of a further example of the sealing structure of FIG. 1A.

FIG. 3B illustrates a side view of a further example of the sealing structure of FIG. 1A.

FIG. 4A illustrates a top view of an example of the sealing structure of FIG. 1A.

FIG. 4B illustrates a top view of a further example of the sealing structure of FIG. 1A.

FIG. 4C illustrates a top view of a further example of the sealing structure of FIG. 1A.

### DETAILED DESCRIPTION

To easily identify the discussion of any particular element or act, the most significant digit or digits in a reference number refer to the figure number in which that element is first introduced.

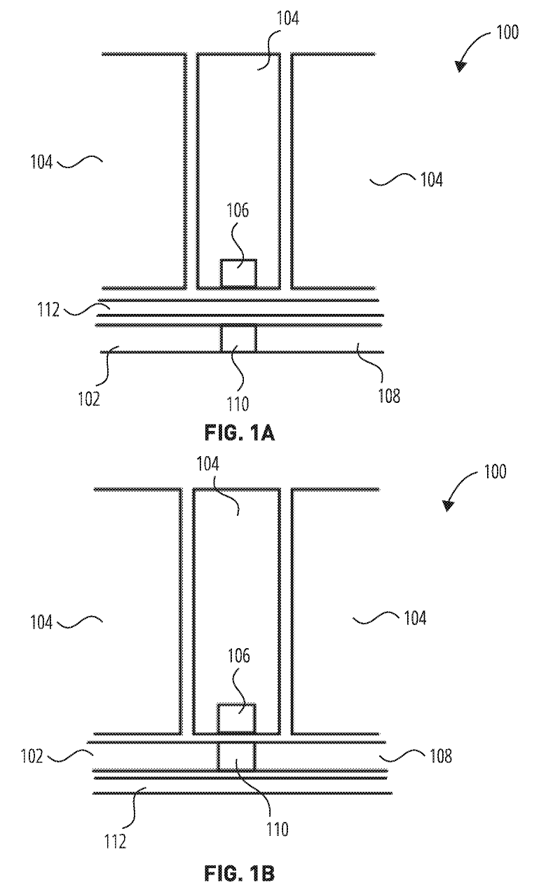

FIGS. 1A and 1B both show a battery assembly 100. The battery assembly 100 may be a battery assembly 100 of a vehicle, for example an electric or hybrid vehicle. The battery assembly 100 may be a secondary or traction battery of the vehicle.

The battery assembly 100 includes a battery housing 102, which is only partially illustrated. The battery housing 102 includes a vent plate 108. Battery cells 104 are disposed within the battery housing 102. Each battery cell 104 includes a battery vent 106, which serves to vent an overpressure within the battery cell 104, for example during malfunction such as during thermal runaway. The vent plate 108 includes a housing vent 110. The housing vent 110 acts to vent gasses from the battery cells 104 outside of the battery housing 102. In particular, gasses vented by a battery cell 104 during malfunction may have a high temperature and/or be combustible, and it is beneficial to vent these outside of the battery housing 102 to prevent battery explosion and/or propagation to other battery cells 104 in the battery assembly 100. The vent plate 108 may include multiple housing vents 110. There may be one or more housing vents 110 for each battery cell 104, for example aligned with each battery vent 106.

In the illustrated examples of FIGS. 1A and 1B the vent plate 108 is at a bottom or lower side of the battery housing 102 and the battery vents 106 are located on a bottom or lower side of the battery cells 104. However, it will be appreciated that the battery vents 106 may be arranged on other sides of the battery cells 104, facing in other directions, for example upwards from an upper or top side of the battery cells 104, or sideways, or some combination. Therefore, in various examples the vent plate 108 may form a top, bottom and/or side wall of the battery housing 102.

The battery assembly 100 also includes a sealing structure 112. The sealing structure 112 may seal or protect the battery cells from ingress of water, moisture, dirt and the like. As described below, the sealing structure 112 seals one or more vents of the battery assembly 100. The sealing structure 112 may be a protective structure, in particular a protective laminate.

In the example of FIG. 1A the sealing structure 112 is disposed between the battery cells 104 and the vent plate 108. In the example of FIG. 1B the sealing structure 112 is disposed on an outer surface of the vent plate 108 so that the vent plate 108 is located between the battery cells 104 and the sealing structure 112. The sealing structure 112 acts to prevent ingress of fluid (e.g., water, water vapour, condensation, spray water) and other contaminants (e.g., dirt) into the battery housing 102, particularly through the housing vent 110.

As described below, the sealing structure 112 is configured to rupture to create a fluid path allowing gases to egress from the battery assembly 100 when gases are vented from the battery cells 104. The sealing structure 112 thereby provides a sealing barrier in normal use, and ruptures to provide gas venting during battery malfunction.

For illustrative clarity, spacings are shown between the battery cells 104, the sealing structure 112, and the vent plate 108. However it will be appreciated that in an assembled battery assembly 100 these components would be in abutment and may be joined to each other as described further below.

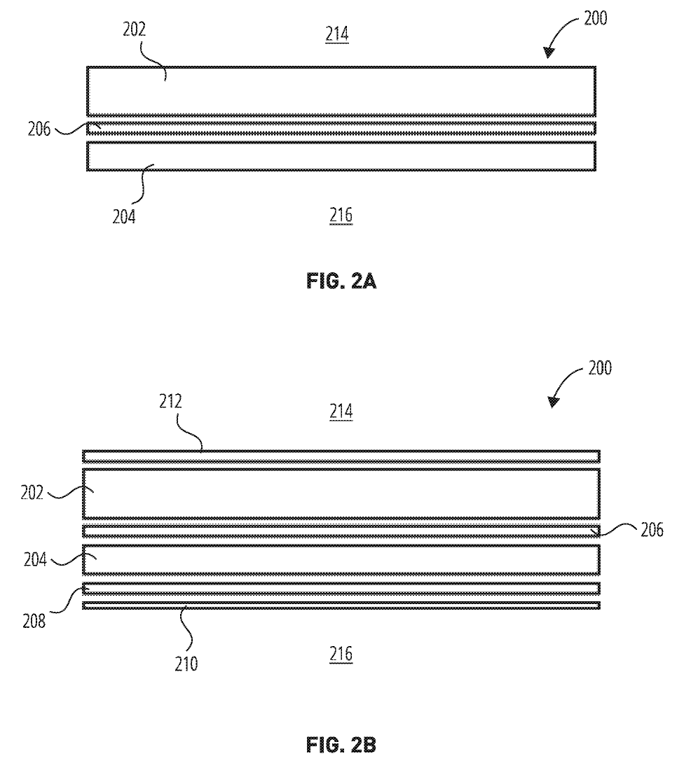

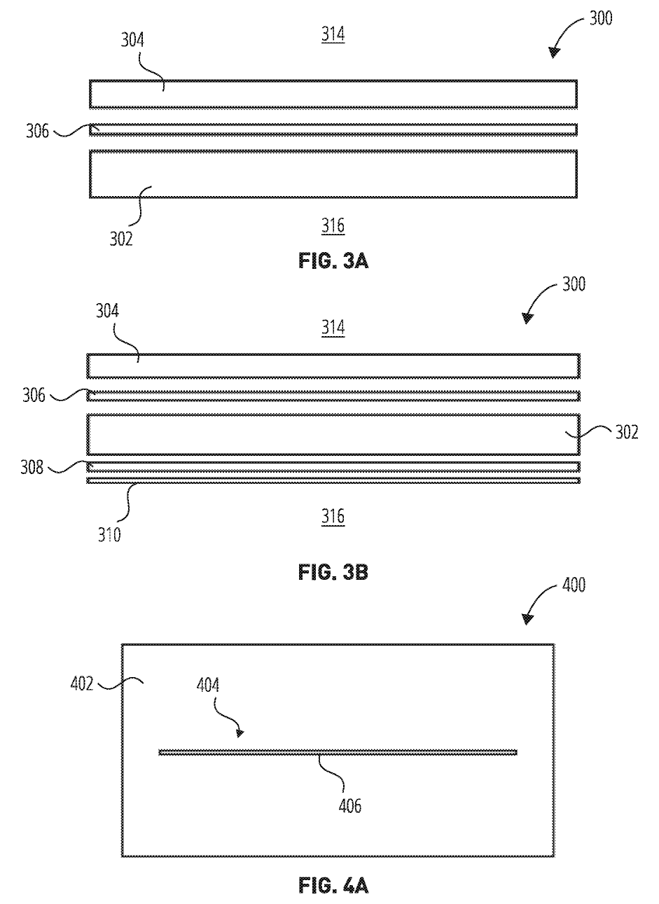

FIGS. 2A to 3B illustrate side views of examples of the sealing structure 112, 200, 300. In these examples the sealing structure 112, 200, 300 is a sealing laminate. The sealing laminate has a multi-layered structure, with different layers attached to each other, in particular adhered to each other. For illustrative clarity, in these Figures the thicknesses the layers are exaggerated, and spacings are shown between the layers, but it will be appreciated that the layers are thin and in contact with each other, in particular attached to each other to form the laminate structure.

FIG. 2A shows a first example of the sealing structure 200. The sealing structure 200 includes a sealing layer 202 and a support layer 204 that are adhered to each other by an adhesive layer 206. In this example, the sealing layer 202 is disposed on the inner side 214 of the sealing structure 200. The sealing layer 202 faces the battery cells in the battery assembly of FIG. 1A, and faces the vent plate 108 in the example of FIG. 1B. The support layer 204 is disposed on the outer side 216. The support layer 204 faces the vent plate in the battery assembly of FIG. 1A, and faces an exterior of the battery assembly 100 in the battery assembly of FIG. 1B.

FIG. 2B shows a similar sealing structure 200 to that of FIG. 2A, with an additional outer adhesive layer 208 on the outer side 216 of the support layer 204. The outer adhesive layer 208 is covered by a release liner 210. In the example of FIG. 1A, the outer adhesive layer 208 is used to adhere the sealing structure 200 to the vent plate in the battery assembly. The release liner 210 is removed during assembly of the sealing structure 200 with the battery assembly. In the example of FIG. 1B, the outer adhesive layer 208 may be used to attach further components of the battery assembly.

In addition, in the example of FIG. 2B the sealing structure 200 includes an inner cover layer 212 on the inner side 214 of the sealing layer 202. The inner cover layer 212 may be adhered or otherwise attached to the sealing layer 202. The inner cover layer 212 may provide some protection to the sealing layer 202. The sealing layer 202 may include openings or areas area of weakness, which are aligned with the battery vent(s) in the example of FIG. 1A, and with the housing vents in the example of FIG. 1B.

FIG. 3A shows a further example sealing structure 300. The sealing structure 300 includes a sealing layer 302 and a support layer 304 that are adhered to each other by an adhesive layer 306. In this example, the support layer 304 is disposed on the inner side 314 of the sealing structure 300. In the example of FIG. 1A the support layer 304 faces the battery cells in the battery assembly, and in the example of FIG. 1B the support layer 304 faces the vent plate. The sealing layer 302 is disposed on the outer side 316. The support layer 304 faces the vent plate in the battery assembly of FIG. 1A and faces the exterior of the battery assembly in the example of FIG. 1B. This is the opposite arrangement to the example of FIG. 2A.

FIG. 3B shows a similar sealing structure 300 to that of FIG. 3A, with an additional outer adhesive layer 308 on the outer side 316 of the sealing layer 302. The outer adhesive layer 308 is covered by a release liner 310. In the example of FIG. 1A the outer adhesive layer 308 is used to adhere the sealing structure 300 to the vent plate in the battery assembly. In the example of FIG. 1B the outer adhesive layer 308 can be used to attach further components of the battery assembly. The release liner 310 is removed during assembly of the sealing structure 300 with the battery assembly. In this example, the support layer 304 provides protection for the sealing layer 302 on the inner side 314.

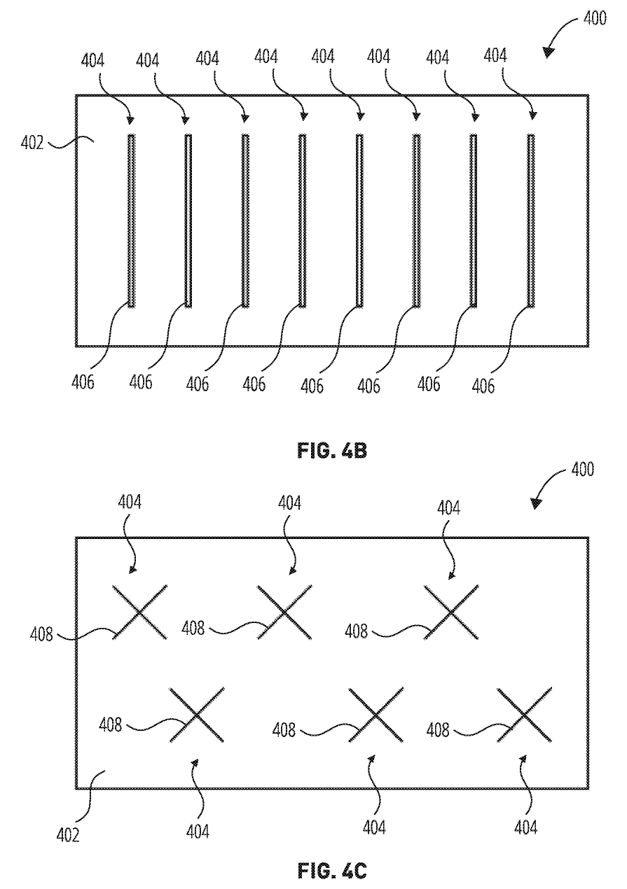

FIGS. 4A to 4C illustrate top or bottom views of the sealing structure 400, which may be any of the example sealing structures 112, 200, 300 described above. These views show the sealing structure 400 from the side of the support layer 402, which may be on the inner side or the outer side of the sealing structure 400 as described above.

In each of the examples of FIGS. 4A to 4C the sealing structure 400 includes an area of weakness 404, and in particular a plurality of areas of weakness 404. The areas of weakness 404 are formed in the support layer 402.

In the example of FIG. 4A the area of weakness 404 comprises a slit 406. The slit 406 is elongate and extends across the support layer 402. In some examples, the slit 406 is positioned so as to be aligned with one or more of the battery vents and/or housing vents (see FIGS. 1A and 1B). In particular, the slit 406 of FIG. 4A is disposed so as to intersect a plurality of battery vents and/or housing vents (see FIGS. 1A and 1B). In other examples, the slit 406 may be non-aligned with the battery vents or housing vents.

In the example of FIG. 4B, the area of weakness 404 comprises at least one slit 406, preferably a plurality of slits 406. The slits 406 extend across the support layer 402. The slits 406 of the example of FIG. 4B are perpendicular compared to the slit 406 of FIG. 4A. Each of the slits 406 may be aligned with a single battery cell, or with multiple battery cells arranged in a column (as illustrated). In some examples, the slits 406 are positioned so as to be aligned with one or more battery vents and/or housing vents (see FIGS. 1A and 1B). In other examples, the slits 406 may be non-aligned with the battery vents and/or housing vents in the battery assembly. The arrangement of the slits 406 may be regular or irregular.

In the example of FIG. 4C, the areas of weakness 404 comprise cross-shaped slits 408. The cross-shaped slits 408 each comprise two perpendicular slits forming a cross. In some examples, the cross-shaped slits 408 are arranged so as to be aligned with the battery vents and/or housing vents of the battery assembly (see FIGS. 1A and 1B). In other examples, the cross-shaped slits 408 may be non-aligned with the battery vents and/or housing vents of the battery assembly. The arrangement of the cross-shaped slits 408 may be regular or irregular.

The areas of weakness 404 in the support layer 402 of the sealing structure 400 provide a fluid path for vented gases in the event of battery malfunction (e.g., thermal runaway). In examples, the areas of weakness 404 each comprise a slit that is formed through the thickness of the support layer 402 and optionally also through the adhesive layer (206, 306, see FIGS. 2A to 3B) that joins the support layer 402 to the sealing layer. That is, the areas of weakness 404 may be formed by through-cuts. In other examples, the slits extend only partly through the thickness of the support layer 402, or may comprise a broken line (e.g., dotted or dashed line of cuts) providing a point of weakness that would rupture under pressure exerted by gases vented from the battery cells. Once ruptured, vented gases can flow through the opening formed in the support layer 402.

In each example described above the sealing layer 202, 302 comprises a rupturable material. The sealing layer 202, 302 is initially intact across the area of the sealing structure 200, 300, 400 and provides a protective barrier, particularly protecting against ingress of moisture and dirt. However, the sealing layer 202, 302 is ruptured when exposed to pressure from gases vented from the batter cells. In particular, when subjected to the pressure of vented gases the sealing layer 202, 302 is configured to rupture to form openings that are aligned with, or at least in fluid communication with, the areas of weakness 404 formed in the support layer 204, 304, 404. In this way, in an initial configuration the sealing structure 200, 300, 400 forms a sealing barrier between the vent plate and the battery cells (FIG. 1A) or across the external surface of the vent plate (FIG. 1B). During battery malfunction (particularly during thermal runaway) gases vented by the battery cells exert a pressure on the sealing structure 200, 300, 400 and form a fluid path through the sealing structure 200, 300, 400 by rupturing the sealing layer 202, 302 and passing through the areas of weakness 404 in the support layer 204, 304, 402.

In examples, the sealing layer 202, 302 comprises a foam material, for example a cellular foam, for example a low-density polyethylene or polyurethane foam. Such a foam material would rupture under the pressure of the vented gases. The rupturable material preferably ruptures when exposed to a pressure of at least 1 bar. The rupturable material preferably ruptures without significant elongation. That is, the rupturable material preferably has low deformation before rupturing under fluid pressure. By way of contrast, unsuitable materials include ethylene-propylene diene monomer (EPDM) and cellular polyurethane, which would exhibit unsuitable deformation and elongation when subject to the pressure of the vented gases, so would not reliably rupture to allow venting of gases. Rupturing is to be understood to mean forming an opening through the thickness of the sealing layer 202, 302. The opening may form by tearing, splitting, breaking, or bursting of the rupturable material.

The rupturing of the sealing layer 202, 302 may be a tearing or splitting of the sealing layer 202, 302. In that respect, the sealing layer 202, 302 may preferably have an anisotropic structure to promote tearing or splitting in one direction when subject to the pressure of the vented gases.

The sealing layer 202, 302 may have a thickness of between 0.1mm and 1mm, for example between 0.1mm and 0.75mm, for example between 0.1mm and 0.5mm, for example between 0.1mm and 0.4mm, for example between 0.2mm and 0.4mm, for example between 0.2mm and 0.3mm, for example about 0.25mm.

The support layer 204, 304, 402 is provided to enhance the robustness of the sealing layer 202, 302, for example to improve resistance to mechanical impact. The support layer 204, 304, 402 also improves the handleability of the sealing structure 112, 200, 300, 400. The support layer 204, 304, 402 may comprise a polymer film, for example polyethylene terephthalate (PET), polypropylene (PP), polyethylene (PE), or monoaxially oriented polypropylene (MOPP).

In examples, the sealing structure 112, 200, 300, 400 also provides a fire retardant barrier. In particular, one or more of the components of the sealing structure 112, 200, 300, 400 may comply with UL94 VTM standards to reduce fire load within the battery assembly.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. Furthermore, the technical effects and/or technical problems described in this description are exemplary rather than limiting; therefore, the disclosure in this description may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements, and/or substantial equivalents.

What is claimed is:

1. A sealing structure for sealing a vent of a battery assembly, the sealing structure comprising a sealing layer comprising a rupturable material extending intactly across the sealing structure, wherein the sealing layer is adapted to rupture and open a fluid path when pressure is exerted on the sealing layer.

2. The sealing structure of claim 1, wherein the sealing layer comprises a foam, for example a cellular foam, for example a low-density polyethylene or polyurethane foam.

3. The sealing structure of claim 1, comprising a support layer adhered to the sealing layer.

4. The sealing structure of claim 3, wherein the sealing structure is a laminate.

5. The sealing structure of claim 3, wherein the support layer comprises a polymer film, for example comprising.

6. The sealing structure of claim 3, wherein the polymer film comprises at least one of polyethylene terephthalate, polypropylene, polyethylene, or monoaxially oriented polypropylene.

7. The sealing structure of claim 3, wherein the support layer comprises an area of weakness and the sealing layer is adapted to rupture in a location corresponding to the area of weakness.

8. The sealing structure of claim 7, further comprising an adhesive layer joining the sealing layer to the support layer across substantially their entire surfaces, and wherein the area of weakness extends through the adhesive layer.

9. The sealing structure of claim 7, wherein the area of weakness comprises a slit, for example an elongate slit or a cross-shaped slit.

10. The sealing structure of claim 7, wherein the area of weakness comprises a through-cut in the support layer.

11. The sealing structure of claim 7, wherein the area of weakness is arranged on the sealing structure so as to be aligned at least one of with a battery vent of the battery cell or with a housing vent of the vent plate.

12. The sealing structure of claim 1, further comprising a cover layer.

13. The sealing structure of claim 1, further comprising an outer adhesive layer for adhering the sealing structure to a surface of the battery assembly, and optionally further comprising a release liner provided on the outer adhesive layer.

14. A battery assembly, comprising:
a battery cell having a battery vent,
a battery housing having a vent plate with a housing vent, and
the sealing structure of claim 1, the sealing structure being positioned to cover at least one of the battery vent or the housing vent.

15. The battery assembly of claim 14, wherein the sealing structure is disposed between the battery cell and the vent plate.

16. The battery assembly of claim 15, wherein the sealing structure comprises a support layer attached to the sealing layer, and wherein the support layer is disposed to face the battery cell and the sealing layer is disposed to face the vent plate.

17. The battery assembly of claim 15, wherein the sealing structure comprises a support layer attached to the sealing layer, and wherein the support layer is disposed to face the vent plate and the sealing layer is disposed to face the battery cell.

18. The battery assembly of claim 14, wherein the vent plate is disposed between the sealing structure and the battery cell.

19. The battery assembly of claim 18, wherein the sealing structure comprises a support layer attached to the sealing layer, and wherein the support layer is disposed to face the vent plate.

20. The battery assembly of claim 17, wherein the sealing structure comprises a support layer attached to the sealing layer, and wherein the sealing layer is disposed to face the vent plate.
